(19) United States
(12) Patent Application Publication
(10) Pub. No.: US 2026/0224432 A1
(43) Pub. Date: Aug. 6, 2026

(54) MODULAR REHABILITATION MASSAGER

(71) Applicant: Jin Tang, Changning (CN)

(72) Inventor: Jin Tang, Changning (CN)

(21) Appl. No.: 19/578,657

(22) Filed: Mar. 25, 2026

(30) Foreign Application Priority Data
Mar. 19, 2026 (CN) 202620341313.1

(51) Int. Cl. A61H 7/00; A61H 9/00

(52) U.S. Cl. CPC A61H 7/004; A61H 7/007; A61H 9/0092; A61H 2201/0107; A61H 2201/0153; A61H 2201/0192; A61H 2201/1676; A61H 2201/169

(57) ABSTRACT

Provided is a modular rehabilitation massager, which includes a lower shell, an upper shell, a telescopic component, and a massage claw component. The telescopic component is provided inside the lower shell and is driven by a first motor to rotate a connection rod, which drives the inner soft rubber to move back and forth along an axial direction to adjust an internal space. The massage claw component is provided inside the upper shell and is driven by a second motor to rotate a gear group and a cam, and the plastic claw is pushed to perform a radial reciprocating motion. The present disclosure solves the problem of existing equipment being unable to adapt to limbs of different thicknesses by adjusting the axial direction of the telescopic component and expanding the airbag radially, achieving a tight fit and flexible wrapping of limbs.

### CROSS-REFERENCE TO RELATED APPLICATIONS

This application claims priority to Chinese Patent Application No. 202620341313.1, filed on March 19, 2026, which is hereby incorporated by reference in its entirety.

### TECHNICAL FIELD

The present disclosure relates to the field of medical rehabilitation equipment technologies, and in particular, to a modular rehabilitation massager.

### BACKGROUND

Massage is an important means of promoting blood circulation and relieving muscle atrophy during physical rehabilitation therapy. However, most existing limb rehabilitation massage equipment adopts an internal cavity structure with fixed size, and this “fixed size fits all” design cannot adapt to individual differences in limb thickness among different patients. When used by patients with thinner limbs, due to the large internal space, the massage head cannot effectively adhere to the skin, resulting in suspended force and weak rehabilitation effect. When used by patients with thicker limbs, it is easy to cause excessive compression, pain, and even secondary damage.

Furthermore, traditional rehabilitation equipment has a relatively simple massage method, usually relying only on simple motor vibration or airbag inflation and deflation to achieve compression. This single mechanical motion mode is difficult to simulate complex “kneading” and “grasping” movements of the human hand and cannot effectively stimulate deep muscle groups radially. At the same time, due to the lack of position adjustment function, massage mechanisms often only function in fixed areas and cannot be adjusted axially according to a specific position of an affected area, resulting in blind spots in rehabilitation treatment and greatly limiting rehabilitation efficiency and user experience.

Therefore, the present disclosure proposes a modular rehabilitation massager to address the shortcomings of existing technology.

The present disclosure aims to provide a modular rehabilitation massager with improved structure that can effectively solve the problems of fixed internal cavity size in existing rehabilitation massage equipment, which makes it difficult to adapt to different thicknesses of limbs, and insufficient deep muscle stimulation and poor rehabilitation effect caused by a single massage method relying solely on simple vibration or compression.

The present disclosure provides a modular rehabilitation massager, including: a lower shell, an upper shell clamped above the lower shell, a telescopic component provided inside the lower shell, and a massage claw component provided inside the upper shell.

Where, the telescopic component includes an inner liner TPE soft rubber, a bottom cover, a first motor, a connection rod, a middle rear shell, and a backpack panel; the backpack panel is fixedly connected to an outer side of the lower shell, and the first motor is provided on an outer side of the backpack panel; an output end of the first motor is fixedly connected to the connection rod, and the inner liner TPE soft rubber is provided inside the lower shell and connected to the connection rod; the middle rear shell is provided at an outer side of the lower shell corresponding to a position of the first motor by buckle, and the bottom cover is provided at a bottom of the lower shell.

Where, the massage claw component includes a second motor, an air pump, a driven gear, a cam, a plastic claw, and a drive gear; the second motor and the air pump are both provided inside the upper shell, and an output end of the second motor is fixedly connected to the drive gear; the drive gear meshes with the driven gear, and the cam is fixedly connected to a bottom of the driven gear, with the plastic claw corresponding to a bottom of the cam; when the air pump is started, airflow is sent to an interior of the inner liner TPE soft rubber through an internal channel to complete inflation; the output end of the first motor drives the connection rod to rotate, the inner liner TPE soft rubber is caused to move up and down inside the lower shell; the second motor drives the drive gear to mesh with the driven gear for transmission, the cam is caused to rotate with the driven gear and push the plastic claw to perform a radial reciprocating motion.

In some embodiments of the present disclosure, the massage claw component and the telescopic component are configured to be disassembled and separated.

In some embodiments of the present disclosure, the massage claw component further includes a rotating shaft and a silicone claw, the rotating shaft is provided at a bottom of the drive gear, and the silicone claw is clamped at bottoms of the plastic claw and the rotating shaft. Through this hierarchical cooperation, the flexibility and elasticity of a massage contact surface can be increased.

In some embodiments of the present disclosure, the rotating shaft cooperates with the drive gear to achieve rotation, and the silicone claw follows a movement of the plastic claw to conform to a massage area and complete kneading vibration.

In some embodiments of the present disclosure, the massage claw component further includes a battery provided inside the upper shell, and the battery is electrically connected to the first motor, the second motor, and the air pump for power supply, thereby achieving independent operation and portable movement of the device.

In some embodiments of the present disclosure, a display screen is provided inside the upper shell, and the display screen is embedded and exposed on a surface of the upper shell, for intuitively displaying a current operating mode and state parameters of the device to a user.

In some embodiments of the present disclosure, a transparent face mask is rotatably connected to a top of the upper shell, and the transparent face mask rotates to cover an outer side of the top of the upper shell and can provide dust protection and observe an internal operation.

In some embodiments of the present disclosure, handles are provided on two sides of the lower shell, and the handles are detachable from the lower shell, rendering it easy for a user to transport the device or maintain stability during massage.

In some embodiments of the present disclosure, the connection rod is connected to the inner liner TPE soft rubber through a connection bracket to convert a transmission of the connection rod into up and down movement of the inner liner TPE soft rubber, ensuring the mechanical stability of an adjustment structure.

In some embodiments of the present disclosure, an action of the air pump inflating an interior of the inner liner TPE soft rubber is coordinated with the up and down movement of the inner liner TPE soft rubber inside the lower shell to complete coordinated massage of extension, contraction, and inflation and contraction, thus achieving three-dimensional wrapping and deep compression of limbs.

The present disclosure has the following beneficial effects.

1. The present disclosure solves the problem of fixed internal cavity size and inability to adapt to different thicknesses of limbs in existing rehabilitation equipment by providing the telescopic component composed of the first motor, the connection rod, and the inner liner soft rubber. It achieves the technical effect of flexibly adjusting the axial position and internal space size of the inner liner according to the patient’s limb condition, ensuring a tight fit between the massage mechanism and the limbs.

2. The present disclosure solves the problem of single massage technique and insufficient deep stimulation caused by traditional equipment relying solely on vibration or airbag compression by providing the massage claw component composed of the second motor, gear group, cam, and plastic claw. It achieves the technical effect of using a cam mechanism to drive the claw to perform a radial reciprocating motion, thereby simulating deep kneading and grasping of muscles by human hands and improving rehabilitation efficiency.

3. The present disclosure uses the air pump to inflate and expand the soft rubber in the inner liner, and cooperates with the axial movement of the telescopic component to solve the problem of difficulty in achieving flexible wrapping through simple mechanical adjustment. It achieves the technical effect of actively filling gaps with air pressure, providing uniform squeezing force, and forming a three-dimensional collaborative massage of inflatable wrapping and mechanical grasping with mechanical kneading.

### BRIEF DESCRIPTION OF DRAWINGS

FIG. 1 is a three-dimensional schematic diagram of a modular rehabilitation massager proposed by the present disclosure.

FIG. 2 is a schematic structural diagram of a display screen of the modular rehabilitation massager proposed by the present disclosure.

FIG. 3 is a schematic structural diagram of a handle of the modular rehabilitation massager proposed by the present disclosure.

FIG. 4 is a schematic structural diagram of a telescopic component of the modular rehabilitation massager proposed by the present disclosure.

FIG. 5 is a schematic structural diagram of a massage claw component of the modular rehabilitation massager proposed by the present disclosure.

FIG. 6 is a schematic structural diagram of a cam of the modular rehabilitation massager proposed by the present disclosure.

FIG. 7 is a schematic diagram of separated upper and lower parts of the modular rehabilitation massager proposed by the present disclosure.

Numeral reference: 1- lower shell; 2- telescopic component; 201- inner liner TPE soft rubber; 202- bottom cover; 203- first motor; 204- connection rod; 205- middle rear shell; 206- backpack panel; 3- massage claw component; 301- second motor; 302- battery; 303- air pump; 304- driven gear; 305- cam; 306- plastic claws; 307- rotating shaft; 308- silicone claws; 309- drive gear; 4- upper shell; 5- handle; 6- transparent face mask; 7- display screen.

### DESCRIPTION OF EMBODIMENTS

In order to clarify the purpose, technical solution, and advantages of the present disclosure, the following will provide a clear and complete description of the technical solution in the embodiments of the present disclosure in combination with the accompanying drawings. Obviously, the described embodiments are only a part of the embodiments of the present disclosure, not all embodiments. Based on the embodiments in the present disclosure, all other embodiments obtained by those skilled in the art without creative work are within the protection scope of the present disclosure.

### Embodiment

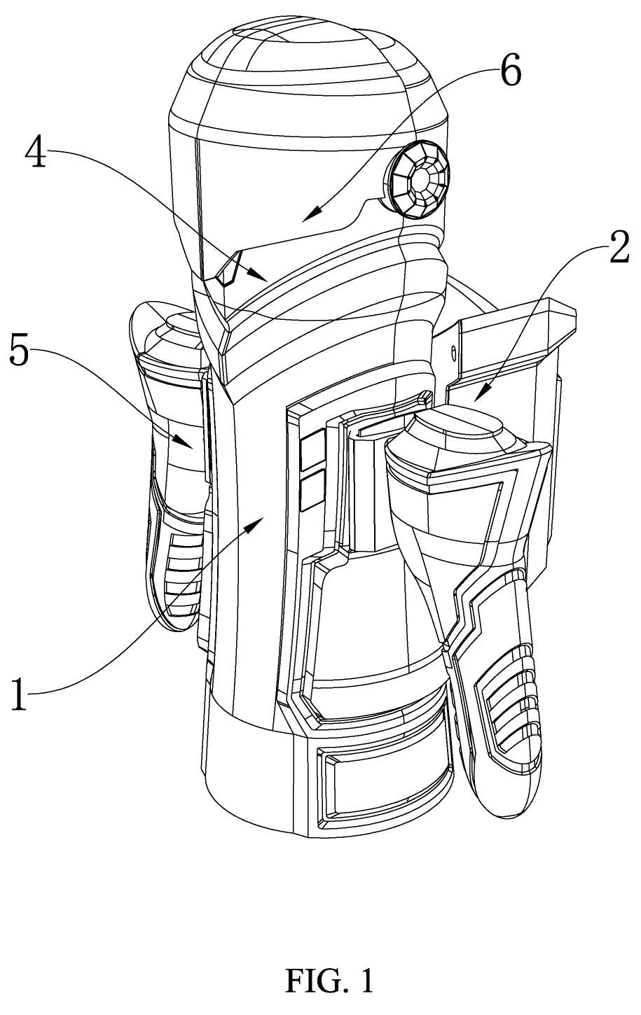

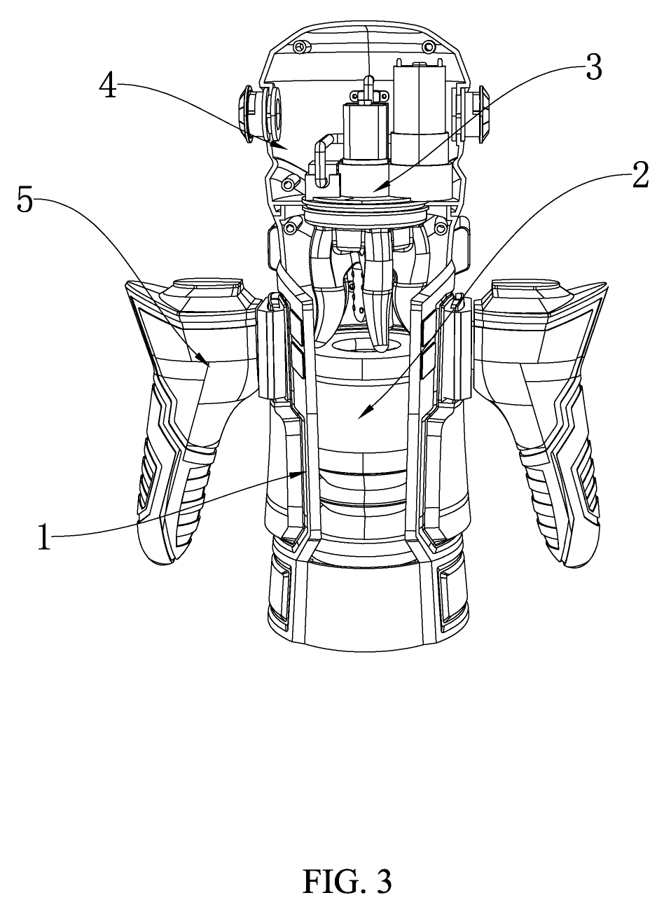

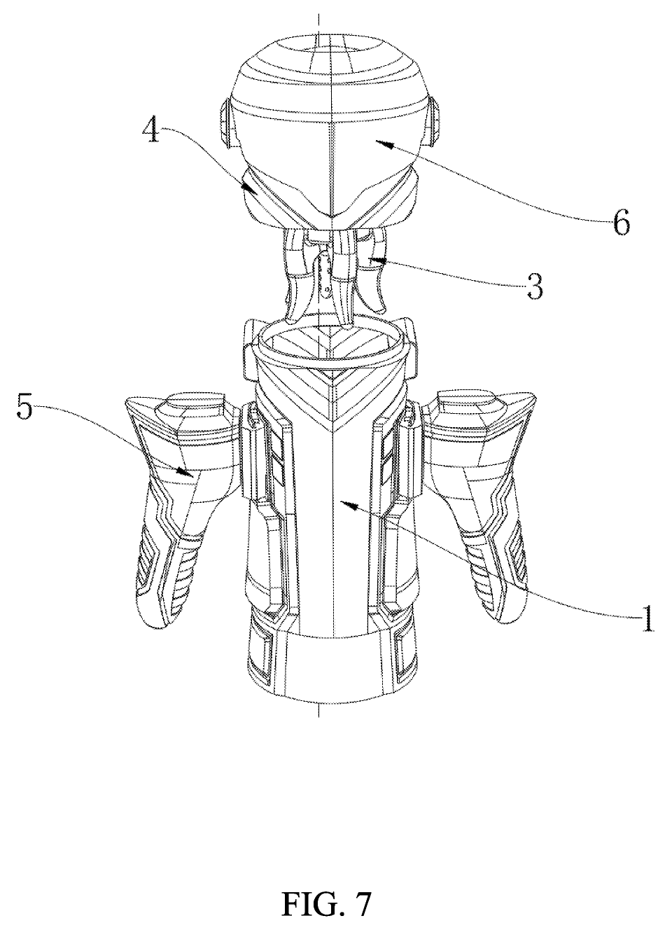

Please refer to FIGS. 1 to 7. An embodiment of the present disclosure provides a modular rehabilitation massager, which aims to solve technical problems of an inability of existing rehabilitation equipment to adapt to different thicknesses of limbs and simulate complex hand kneading movements, as well as a lack of synergy between airbag compression and mechanical massage, resulting in a single rehabilitation effect and poor fit.

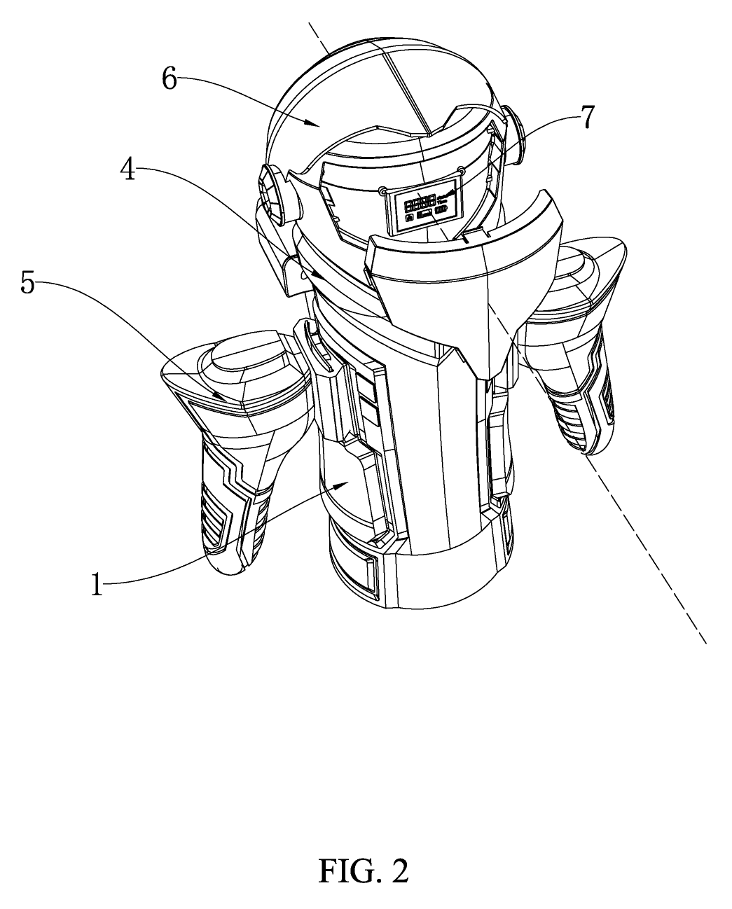

As shown in FIGS. 1 and 2, a main structure of the modular rehabilitation massager includes a lower shell 1, and an upper shell 4 fixed to a top of the lower shell 1 through a buckle structure. The lower shell 1 serves as a basic support component of the entire device, and its interior forms a receiving space for installing an adjustment mechanism. The upper shell 4 serves as a core functional component carrier covering the lower shell 1, and the two together enclose to form a complete equipment shell. Outer walls of the lower shell 1 on two sides can be disassembled and provided with handles 5, and the handles 5 extend radially outward along the lower shell 1, rendering it convenient for a user to transport or maintain equipment stability during use. A top of the upper shell 4 is connected to a transparent face mask 6, and the transparent face mask 6 can be flipped to cover or expose a top area of the upper shell 4, thereby playing a role in dust prevention and protecting internal precision components, the upper shell 4 is further provided with a display screen 7 inside, and the display screen 7 is embedded and exposed on a surface of the upper shell 4, the display screen 7 is configured for real-time display of device working state and massage mode information.

A core function of the device is composed of a telescopic component 2 provided inside the lower shell 1 and a massage claw component 3 provided inside the upper shell 4. The telescopic component 2 is configured to achieve axial telescopic adjustment of the inner liner through mechanical transmission to adapt to different limb sizes, and the massage claw component 3 is configured to achieve multi-dimensional kneading, vibration, and cooperate with a pneumatic system to complete pneumatic compression massage through mechanical linkage. The two are distributed vertically in space and functionally cooperate with each other.

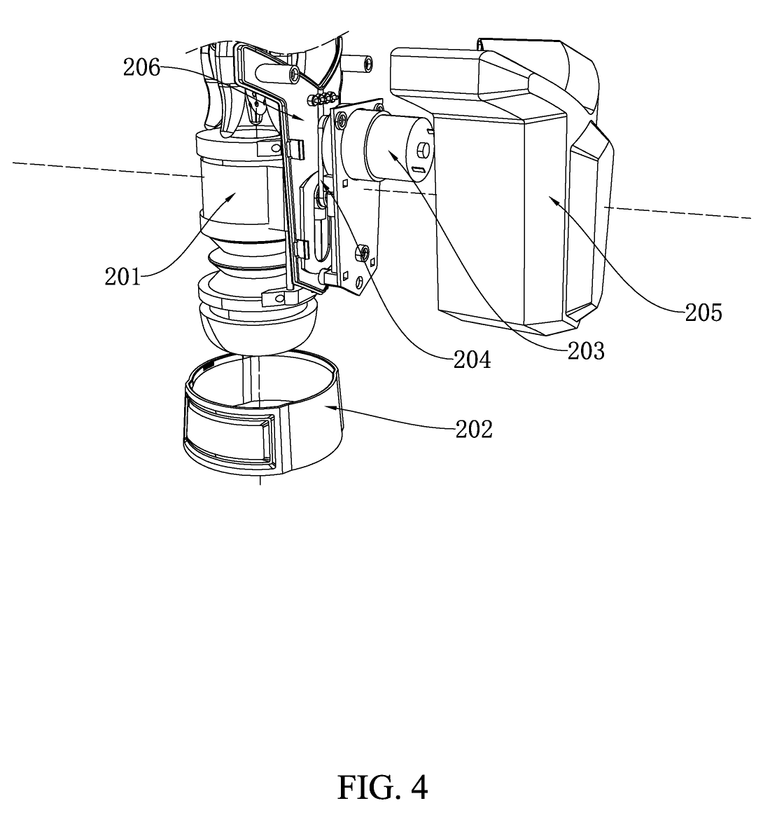

As shown in FIG. 4, the telescopic component 2 mainly consists of a first motor 203, a connection rod 204, an inner liner TPE soft rubber 201, and a backpack panel 206. The backpack panel 206 is fixedly connected to an outer side wall of the lower shell 1 by screws or buckles, and the first motor 203 is fixedly provided on an outer side of the backpack panel 206. An output shaft of the first motor 203 passes through the backpack panel 206, extends to an inner side of the lower shell 1, and is fixedly connected to one end of the connection rod 204. The other end of the connection rod 204 is rotatably connected or hinged to the inner liner TPE soft rubber 201 through a connection bracket. The inner liner TPE soft rubber 201 is provided inside the lower shell 1 as a flexible medium that directly contacts the limbs. The middle rear shell 205 is installed to an outer side of the lower shell 1 by a buckle to shield and protect a motor at a position corresponding to the first motor 203. The bottom cover 202 is fixedly provided at a bottom of the lower shell 1 to close a lower opening. This structure allows the first motor 203 to drive the connection rod 204 to rotate, and the inner liner TPE soft rubber 201 is driven to move back and forth along an axial direction inside the lower shell 1, thereby changing a size of an internal massage space.

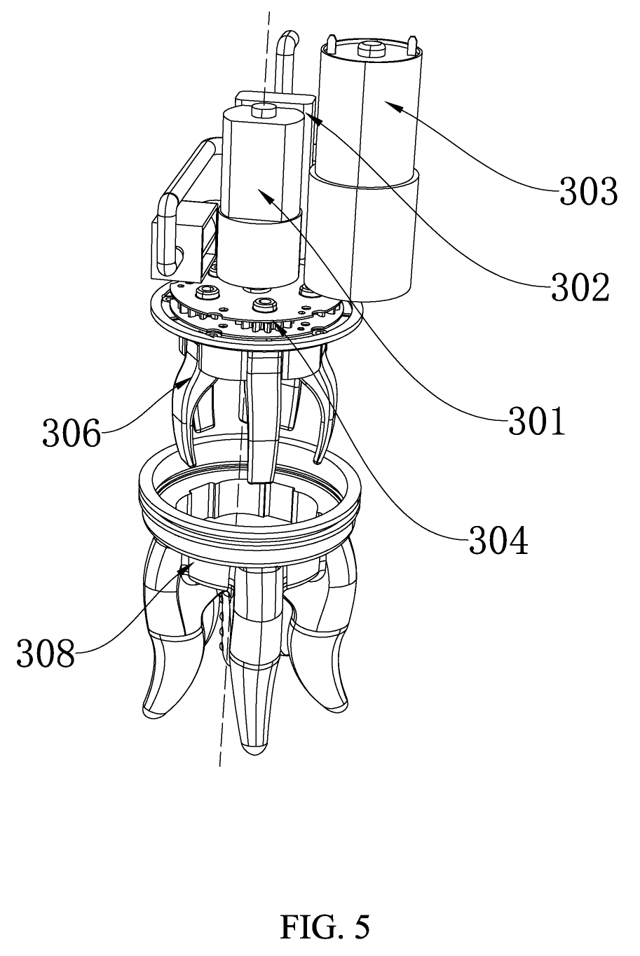

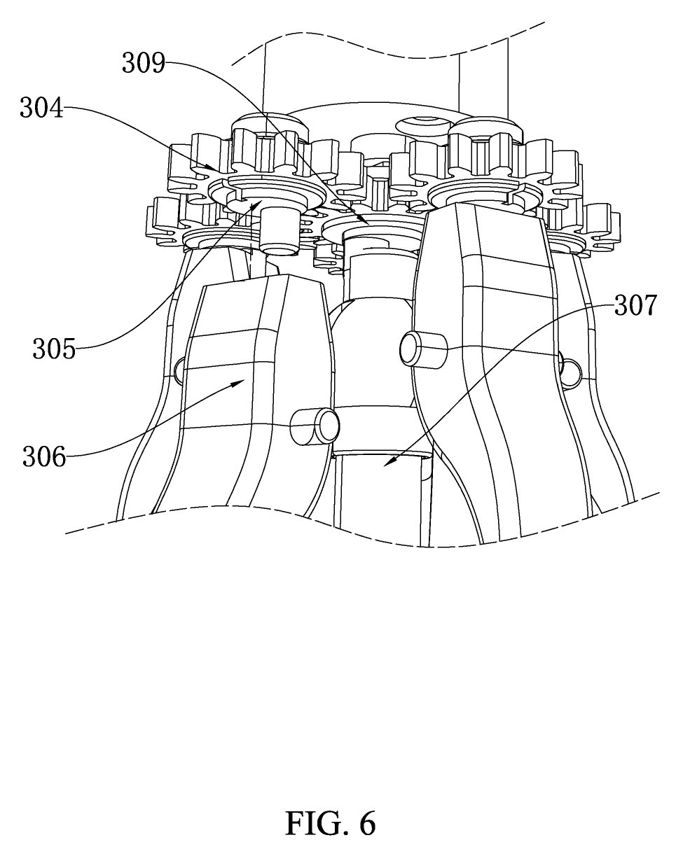

As shown in FIGS. 5 and 6, the massage claw component 3 is mainly composed of a second motor 301, a transmission gear set, a cam 305, and a plastic claw 306. The second motor 301 is fixedly provided inside the upper shell 4 as a power source of kneading. An output end of the second motor 301 is fixedly connected to a drive gear 309, and a driven gear 304 is provided beside the drive gear 309 for rotation. The drive gear 309 and the driven gear 304 mesh with each other to transmit torque and adjust speed. The cam 305 is fixedly provided at a bottom of the driven gear 304 and rotates synchronously with it. The cam 305 has an eccentric contour or a specific curved contour. The plastic claw 306 is slidably provided inside the upper shell 4, and its top end slides against a contour surface of the cam 305. This structure uses a radius change when the cam 305 rotates to push the plastic claw 306 to perform a radial reciprocating motion, thereby simulating hand grasping and pinching actions.

To solve the problem of not being able to balance adaptive adjustment and inflation coordination technology mentioned above, the modular rehabilitation massager further includes an air pump 303 and a battery 302. The air pump 303 forms a specific structural coordination and connection relationship with the inner liner TPE soft rubber 201 to achieve the function of air pressure compression massage, as well as the suction action of the inner liner TPE soft rubber 201. Please refer to FIGS. 4 and 5 in detail. The core pneumatic and power supply structure is described below. The air pump 303 and the battery 302 are fixedly provided inside the upper shell 4. The air pump 303 is configured to provide high-pressure airflow, and the battery 302 is configured to provide independent electrical energy for the whole machine. The battery 302 is electrically connected to the first motor 203, the second motor 301, and the air pump 303 to provide stable working voltage and ensure that the equipment is disconnected from an external power supply for independent operation. An output end of the air pump 303 is connected to a sealed cavity inside the inner liner TPE soft rubber 201 through an internal channel. The inner liner TPE soft rubber 201 is made of a material with good elasticity. Its function is to act as a volume change executing component driven by air pressure. When the equipment is assembled and running, the air pump 303 starts to send air flow to an interior of the inner liner TPE soft rubber 201 to compress and reduce its inner wall. The inner wall is provided with multiple protrusions to massage the skin. With the first motor 203 driving the inner liner TPE soft rubber 201 to move up and down inside the lower shell 1, this mechanical axial displacement is combined with a radial expansion of the airbag to ensure that the inner liner TPE soft rubber 201 can tightly adhere to and compress human limbs of different thicknesses, thus forming a multi-dimensional air pressure compression and wrapping massage effect.

At the same time, in order to improve the comfort of mechanical kneading and the smoothness of multi-directional transmission, the massage claw component 3 is correspondingly provided with a rotating shaft 307 and a silicone claw 308 at an execution end. The rotating shaft 307 is provided and embedded at a corresponding position at a bottom of the drive gear 309. The rotating shaft 307 is configured to reduce contact friction and provide multi-directional rolling freedom. The silicone claw 308 is made of soft and skin friendly material, and is clamped at bottoms of the plastic claw 306 and the rotating shaft 307. The silicone claw 308 serves as a flexible contact part that directly adheres to a massage area of the human body. Its function is to buffer a rigid impact brought by the plastic claw 306 and transmits the kneading vibration force. In assembled and matched state, a bottom of the rotating shaft 307 is provided with a flexible claw. When the second motor 301 drives the drive gear 309 to rotate, and the cam 305 pushes the plastic claw 306 to perform a radial reciprocating motion. The rotating shaft 307 cooperates with the drive gear 309 to rotate and achieve a flexible rotation inside the silicone claw 308, realizing internal flexible claw rotation. This multi-stage transmission and contact matching structure not only makes a movement trajectory of the silicone claw 308 with the plastic claw 306 to be smoother, but also ensures that the silicone claw 308 can complete deep kneading and vibration combined massage actions when fitting the human muscle and skin, thereby avoiding discomfort caused by rigid mechanical transmission and enhancing the practical value of the overall equipment rehabilitation therapy.

On the basis of the above embodiments, the present disclosure may also include the following preferred technical solutions.

In an implementation mode, in order to further improve the overall protective performance of the equipment and optimize the integrity of the appearance structure, a middle rear shell 205 is connected to the outer side of the lower shell 1 corresponding to a position of the first motor 203. The middle rear shell 205 is made of high-strength hard plastic material and tightly covers an outer area of the first motor 203 and the backpack panel 206. The middle rear shell 205 not only plays a role in dust and water resistance and isolates motor operation noise, but also reinforces the connection at the backpack panel 206. A bottom edge of the lower shell 1 is fixedly provided with a bottom cover 202 through screws or clamp slot structure. The shape of the bottom cover 202 is adapted to a contour of a bottom opening of the lower shell 1, and the bottom cover 202 completely closes a bottom opening of the lower shell 1. The bottom cover 202 ensures a mechanical structure of the internal telescopic component 2 not exposed, and provides a stable support base for a placement of the entire machine.

In an implementation mode, in order to enhance the portability and human-computer interaction experience of the device, handles 5 are provided on outer walls of the left and right sides of the lower shell 1 in a snap fit manner. The handles 5 extend radially outward along the lower shell 1 and have a structure that conforms to the ergonomic grip curve. The surface of the handles 5 is provided with anti-slip textures for a user to firmly grip or transport the equipment with two hands. A top edge of the upper shell 4 is connected to the transparent face mask 6 through a damping shaft or hinge mechanism. The transparent face mask 6 can be flipped and opened with a top edge of the upper shell 4 as a fulcrum. When the transparent face mask 6 is in a closed state, it completely covers the top operating area of the upper shell 4 to prevent dust accumulation or accidental touch. When the transparent face mask 6 is in an open state, the internal structure is exposed for the user to observe the operating condition or perform cleaning.

In an implementation mode, in order to achieve visual operation and real-time state monitoring, a surface of the upper shell 4 is provided with an installation slot that is compatible with the size of the display screen 7. The display screen 7 is embedded in the installation slot and exposed on the surface of the upper shell 4 through adhesive bonding or buckle fixation. The display screen 7 is electrically connected to an internal control motherboard, and is configured to display a current massage mode, airbag pressure value, remaining power, and running time data in real time. The display screen 7 serves as a human-computer interaction window, rendering it convenient for the user to intuitively adjust equipment operating parameters according to rehabilitation needs.

In an implementation mode, in order to achieve a coherent and uniform multi-point biomimetic massage effect, the cam 305 is provided with a specific eccentricity or non-circular surface contour structure. The number of the plastic claws 306 is set to multiple and evenly spaced along a circumference of the cam 305. When the second motor 301 drives the driven gear 304 to continuously rotate the cam 305, an eccentric contour surface of the cam 305 sequentially pushes against a bottom end of each of the plastic claws 306, so that each plastic claw 306 strictly extends outward according to the predetermined phase difference, and is orderly retracted inward under the action of the reset spring or mechanical limit structure. The periodic radial reciprocating motion of the plastic claw 306 can be accurately transmitted to the outer silicone claw 308, thereby forming a wave like massage sensation on the surface of the human skin similar to finger rotation kneading.

The specific working principle of the modular rehabilitation massager of the present disclosure is as follows.

When rehabilitation massage is required, the first motor 203 is started, and the output end of the first motor 203 rotates and drives the connection rod 204 to undergo displacement. Due to the transmission cooperation between the connection rod 204 and the inner liner TPE soft rubber 201 through the connection bracket, the connection rod 204 drives the inner liner TPE soft rubber 201 to move back and forth axially in an inner space of the lower shell 1. This movement process can adjust a coverage position of the inner liner TPE soft rubber 201 to adapt to different limb lengths and massage area requirements, achieving preliminary positioning.

At the same time or after the axial adjustment is completed, start the air pump 303. The compressed gas generated by the air pump 303 is injected into the sealed cavity inside the inner liner TPE soft rubber 201 through the internal air passage. The inner liner TPE soft rubber 201 is driven by air pressure to expand and contract towards the center, thereby tightly adhering to and flexibly wrapping around the human limbs. This air pressure compression action eliminates the gap between the mechanical structure and the human body, thereby providing a stable foundation for subsequent mechanical massage.

Next, the second motor 301 starts to rotate, and the output end of the second motor 301 drives the drive gear 309 to rotate at high speed. The drive gear 309 meshes with the driven gear 304 and synchronously rotates with the cam 305 fixed at the bottom of the driven gear 304. Due to the eccentric or specific curved contour of the cam 305, its contour surface continuously pushes the plastic claw 306 during rotation, forcing the plastic claw 306 to make reciprocating expansion and contraction movements in the radial direction. At the same time, the soft claw embedded in the rotating shaft 307 at the bottom of the drive gear 309 that rotates and connects to the silicone claw 308 cooperate with the rotation of the gear group, the silicone claw 308 can produce multi-directional vibration and kneading effect while being pressed radially with the plastic claw 306. Through an axial adjustment of the telescopic component 2, a pneumatic wrapping of the pneumatic system, and the mechanical kneading of the massage claw component 3, the three work together. This device effectively solves the pain point of traditional equipment’s single function and achieves deep muscle rehabilitation therapy.

The above content is only specific implementation mode of the present disclosure, but the protection scope of the present disclosure is not limited to this. Any person familiar with the technical field can easily think of changes or replacements within the disclosed technical scope of the present disclosure, which should be included in the protection scope of the present disclosure. Therefore, the protection scope of the present disclosure should be subject to the protection scope of the claims.

What is claimed is:

1. A modular rehabilitation massager, comprising: a lower shell, an upper shell clamped above the lower shell, a telescopic component provided inside the lower shell, and a massage claw component provided inside the upper shell; wherein the telescopic component comprises an inner liner TPE soft rubber, a bottom cover, a first motor, a connection rod, a middle rear shell, and a backpack panel; the backpack panel is fixedly connected to an outer side of the lower shell, and the first motor is provided on an outer side of the backpack panel; an output end of the first motor is fixedly connected to the connection rod, and the inner liner TPE soft rubber is provided inside the lower shell and connected to the connection rod; the middle rear shell is provided at an outer side of the lower shell corresponding to a position of the first motor by buckle, and the bottom cover is provided at a bottom of the lower shell; the massage claw component comprises a second motor, an air pump, a driven gear, a cam, a plastic claw, and a drive gear; the second motor and the air pump are both provided inside the upper shell, and an output end of the second motor is fixedly connected to the drive gear; the drive gear meshes with the driven gear, and the cam is fixedly connected to a bottom of the driven gear, with the plastic claw corresponding to a bottom of the cam; when the air pump is started, airflow is sent to an interior of the inner liner TPE soft rubber through an internal channel to complete inflation; the output end of the first motor drives the connection rod to rotate, the inner liner TPE soft rubber is caused to move up and down inside the lower shell; the second motor drives the drive gear to mesh with the driven gear for transmission, the cam is caused to rotate with the driven gear and push the plastic claw to perform a radial reciprocating motion.

2. The modular rehabilitation massager according to claim 1, wherein the massage claw component and the telescopic component are configured to be disassembled and separated.

3. The modular rehabilitation massager according to claim 1, wherein the massage claw component further comprises a rotating shaft and a silicone claw, the rotating shaft is provided at a bottom of the drive gear, and the silicone claw is clamped at bottoms of the plastic claw and the rotating shaft.

4. The modular rehabilitation massager according to claim 3, wherein the rotating shaft cooperates with the drive gear to achieve rotation, and the silicone claw follows a movement of the plastic claw to conform to a massage area and complete kneading vibration;
a flexible claw is provided at a center position of the silicone claw, and the flexible claw is fixedly connected to an outer side of the rotating shaft.

5. The modular rehabilitation massager according to claim 1, wherein the massage claw component further comprises a battery provided inside the upper shell, and the battery is electrically connected to the first motor, the second motor, and the air pump for power supply.

6. The modular rehabilitation massager according to claim 1, wherein a display screen is provided inside the upper shell, and the display screen is embedded and exposed on a surface of the upper shell.

7. The modular rehabilitation massager according to claim 1, wherein a transparent face mask is rotatably connected to a top of the upper shell, and the transparent face mask rotates to cover an outer side of the top of the upper shell.

8. The modular rehabilitation massager according to claim 1, wherein handles are provided on two sides of the lower shell, and the handles are detachable from the lower shell.

9. The modular rehabilitation massager according to claim 1, wherein the connection rod is connected to the inner liner TPE soft rubber through a connection bracket to convert a transmission of the connection rod into up and down movement of the inner liner TPE soft rubber.

10. The modular rehabilitation massager according to claim 1, wherein an action of the air pump inflating an interior of the inner liner TPE soft rubber is coordinated with the up and down movement of the inner liner TPE soft rubber inside the lower shell to complete coordinated massage of extension, contraction, and inflation.
